(19) United States
(12) Patent Application Publication
(10) Pub. No.: US 2020/0002491 A1
(43) Pub. Date: Jan. 2, 2020

(54) STRETCHED FILM AND METHOD FOR PRODUCING STRETCHED FILM

(71) Applicant: KANEKA CORPORATION, Osaka-shi (JP)

(72) Inventors: Kenichiro SHIMADA, Otsu-shi (JP); Nagahiro MASUDA, Otsu-shi (JP); Naoto KATAOKA, Otsu-shi (JP)

(73) Assignee: KANEKA CORPORATION, Osaka-shi (JP)

(21) Appl. No.: 16/569,265

(22) Filed: Sep. 12, 2019

Related U.S. Application Data
(63) Continuation of application No. PCT/JP2018/010067, filed on Mar. 14, 2018.

(30) Foreign Application Priority Data
Mar. 15, 2017 (JP) 2017-050530

(51) Int. Cl. C08J 5/18; B32B 27/30; B29C 55/00; G02B 5/30; G02B 1/08; G02B 1/14

(52) U.S. Cl. CPC C08J 5/18; B32B 27/308; G02B 1/14; G02B 5/3083; G02B 1/08; B29C 55/005

(57) ABSTRACT

Provided are: a stretched film having excellent heat resistance, dimensional stability, mechanical properties, and adhesiveness; and a method for producing a stretched film. The present invention relates to: a stretched film containing acrylic rubber particles and an acrylic resin having a glass transition temperature of 120° C. or higher, the stretched film being characterized by having a shrinkage rate of 1.5% or less when left standing at 85° C. and 85% RH for 120 hours, and having an endurable number of cycles, by MIT flex test, of 350 times or more; and a method for producing a stretched film.

### TECHNICAL FIELD

The present invention relates to a stretched film which can be used for an optical film or the like, and a method for producing the stretched film.

### BACKGROUND ART

A large number of optical films are used in liquid crystal display devices. In the liquid crystal display devices, two polarizing plates are usually disposed on both sides of a liquid crystal cell. As the polarizing plates, that in which polarizer protective films for protecting a polarizer are adhered to both sides of the polarizer is generally used. As the polarizer protective film, an optical film having high transparency is used. Optical films made of cellulose-based materials are often used, but for the purpose of improving durability and the like, it has been proposed to use optical films made of acrylic-based resins as the polarizer protective film (for example, Patent Documents 1 and 2). However, these acrylic resin-based films are sometimes insufficient in mechanical properties, especially flexibility, depending on the application. To solve this problem, stretched films may be used. In addition, use of acrylic rubber particles in an acrylic stretched film has been studied in order to further improve mechanical properties even in the case of an acrylic stretched film (Patent Document 3).
Patent Document 1: Japanese Unexamined Patent Application, Publication No. 2009-205135
Patent Document 2: Japanese Unexamined Patent Application, Publication No. 2015-143842
Patent Document 3: Japanese Unexamined Patent Application, Publication No. 2009-84574

### DISCLOSURE OF THE INVENTION

### Problems to be Solved by the Invention

According to the studies by the present inventors, it has been found that, although mechanical properties are improved by blending acrylic rubber particles, there is a problem that shrinkage ratio is increased in a high temperature and high humidity environment. When the optical film is used as a polarizer protective film, shrinkage of the optical film is accompanied by distortion of the entire polarizing plate, and this may result in lowered contrast or peripheral unevenness to the liquid crystal display device. It has also been found that blending the acrylic rubber particles causes cohesive fracture due to the acrylic rubber particles in the vicinity of the surface of the optical film, when the optical film is bonded to the polarizer, and this results in insufficient adhesion to the polarizer.

The present invention has been made to solve the above problems. It is an object of the present invention to provide a stretched film and a method for producing the stretched film, the stretched film being excellent in mechanical properties, in particular, flexibility (MIT folding endurance), having adhesive strength, and being suitable for use as an optical film having a small dimensional change rate in a high temperature and high humidity environment.

### Means for Solving the Problems

In order to solve the above-mentioned problem, the present inventors have made diligent research and have completed the present invention.

Namely, the present invention relates to the following.
<1>

A first aspect of the present invention is a production method of a stretched film comprising acrylic resin having a glass transition temperature of 120° C. or more (A) and acrylic rubber particle (B) in a content of 1% by weight to 50% by weight, in which stretching temperature during the stretching is T_{g}+20° C. to T_{g}+55° C.
<2>

A second aspect of the present invention is the production method according to the first aspect, in which the stretched film has shrinkage ratio of 1.5° or less when the stretched film is left to stand in an atmosphere at 85° C. and 85% RH for 120 hours and an MIT double fold number of 350 counts or more.
<3>

A third aspect of the present invention is the production method according to the first or second aspect, in which the acrylic rubber particle (B) is a core-shell type elastic body having a core layer comprising a rubber-like polymer and a shell layer comprising a glass-like polymer, and in which an average dispersion length of the core-shell type elastic body is 150 nm to 300 nm.
<4>

A fourth aspect of the present invention is the production method according to any one of the first to third aspects, in which, when the stretched film is attached to a polycarbonate film with an adhesive, a value of 90° peel strength is 1.0 N/cm or more in an atmosphere at 23° C. and 50% RH.
<5>

A fifth aspect of the present invention is the production method according to any one of the first to fourth aspects, in which the acrylic resin having a glass transition temperature of 120° C. or more (A) has a ring structure in a main chain.
<6>

A sixth aspect of the present invention is the production method according to the fifth aspect, in which the ring structure is at least one selected from the group consisting of a glutarimide ring, a lactone ring, maleic anhydride, maleimide and glutaric anhydride.
<7>

A seventh aspect of the present invention is the production method according to the fifth or sixth aspect, in which a content of the ring structure in the acrylic resin having a glass transition temperature of 120° C. or more (A) is 2% by weight to 80% by weight.
<8>

An eighth aspect of the present invention is the production method according to any one of the fifth to seventh aspects, in which the ring structure includes the following general formula (1).

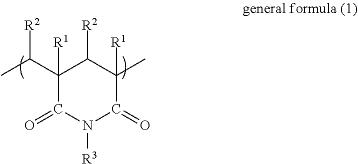

in which R¹ and R² each independently represent a hydrogen atom or an alkyl group having 1 to 8 carbon atoms, and R³ represents an alkyl group having 1 to 18 carbon atoms, a cycloalkyl group having 3 to 12 carbon atoms or an aryl group having 6 to 10 carbon atoms.
<9>

A ninth aspect of the present invention is the production method according to any one of the first to eighth aspects, in which the stretched film has shrinkage ratio of 0.1% or more and 1.5% or less when the stretched film is left to stand in an atmosphere at 85° C. and 85% RH for 120 hours.
<10>

A tenth aspect of the present invention is the production method according to any one of the first to ninth aspects, in which the stretched film is provided with an easy adhesive layer on one surface or each of both surfaces of the stretched film.
<11>

An eleventh aspect of the present invention is a stretched film comprising acrylic resin having a glass transition temperature of 120° C. or more (A) and acrylic rubber particle (B) in a content of 1% by weight to 50% by weight, in which the stretched film has shrinkage ratio of 1.5% or less when the stretched film is left to stand in an atmosphere at 85° C. and 85% RH for 120 hours and an MIT double fold number of 350 counts or more.
<12>

A twelfth aspect of the present invention is the stretched film according to the eleventh aspect, in which the acrylic rubber particle (B) is a core-shell type elastic body having a core layer comprising a rubber-like polymer and a shell layer comprising a glass-like polymer, and in which an average dispersion length of the core-shell type elastic body is 150 to 300 nm.
<13>

A thirteenth aspect of the present invention is the stretched film according to the eleventh or twelfth aspect, in which, when the stretched film is attached to a polycarbonate film with an adhesive, a value of 90° peel strength is 1.0 N/cm or more in an atmosphere at 23° C. and 50% RH.
<14>

A fourteenth aspect of the present invention is the stretched film according to any one of the eleventh to thirteenth aspects, in which the acrylic resin having a glass transition temperature of 120° C. or more (A) has a ring structure in a main chain.
<15>

A fifteenth aspect of the present invention is the stretched film according to the fourteenth aspect, in which the ring structure is at least one selected from the group consisting of a glutarimide ring, a lactone ring, maleic anhydride, maleimide and glutaric anhydride.
<16>

A sixteenth aspect of the present invention is the stretched film according to the fourteenth or fifteenth aspect, in which a content of the ring structure in the acrylic resin having a glass transition temperature of 120° C. or more (A) is 2% by weight to 80% by weight.
<17>

A seventeenth aspect of the present invention is the stretched film according to any one of the fourteenth to sixteenth aspects, in which the ring structure includes the following general formula (1);

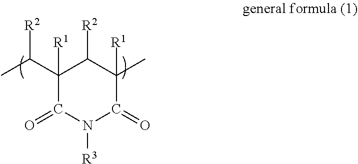

in which R¹ and R² each independently represent a hydrogen atom or an alkyl group having 1 to 8 carbon atoms, and R³ represents an alkyl group having 1 to 18 carbon atoms, a cycloalkyl group having 3 to 12 carbon atoms or an aryl group having 6 to 10 carbon atoms.
<18>

An eighteenth aspect of the present invention is the stretched film according to any one of the eleventh to seventeenth aspects, in which the stretched film has shrinkage ratio of 0.1% or more and 1.5% or less when the stretched film is left to stand in an atmosphere at 85° C. and 85% RH for 120 hours.
<19>

A nineteenth aspect of the present invention is the stretched film according to any one of the eleventh to eighteenth aspects, in which the stretched film is provided with an easy adhesive layer on one surface or each of both surfaces of the stretched film.

### Effects of the Invention

According to the present invention, it is possible to provide a stretched film and a method for producing the stretched film, the stretched film being excellent in mechanical properties, having excellent adhesive strength, and being suitable for use as an optical film, in particular a polarizer protective film, having a small dimensional change rate at high temperature and high humidity.

### PREFERRED MODE FOR CARRYING OUT THE INVENTION

Although an embodiment of the present invention is described below, the present invention is not limited thereto. The present invention is not limited to the respective configurations described below, and various modifications can be made within the scope shown in the claims. Embodiments and Examples obtained by appropriately combining technical means disclosed in different embodiments and Examples are also included in the technical scope of the present invention. All of the academic documents and patent documents described herein are incorporated herein by reference. Note that, unless otherwise specified in this specification, “A to B” representing a numerical range means “A or more (including A and larger than A) and B or less (including B and smaller than B)”.

The present invention is characterized in that a stretched film containing acrylic resin having a glass transition temperature of 120° C. or more (A) and 1% by weight to 50% by weight of acrylic rubber particle (B), wherein the stretched film has a shrinkage ratio of 1.5% or less when the stretched film is left to stand in an atmosphere at 85° C. and 85% RH for 120 hours and the stretched film has the MIT double fold number of 350 counts or more.

### (Stretched Film)

The stretched film of the present invention is a stretched film comprising acrylic resin having a glass transition temperature of 120° C. or more (A) (hereinafter sometimes referred to as acrylic resin (A)) and acrylic rubber particle (B) in a content of 1% to 50% by weight. Here, an acrylic resin composition containing acrylic resin having a glass transition temperature of 120° C. or more (A) and acrylic rubber particle (B) in a content of 1% by weight to 50% by weight is defined as an acrylic resin composition.

The stretched film of the present invention has an improved shrinkage ratio when the stretched film is left to stand in an atmosphere at 85° C. and 85% RH for 120 hours, has an excellent MIT folding endurance, and has an improved 90° peel strength when the stretched film is used as a polarizer protective film; the 90° peel strength being tested, when an easy adhesive is applied to one surface of the stretched film and the easy adhesive is then bonded to a polycarbonate film using an instant adhesive, by peeling the polycarbonate film from the stretched film in an atmosphere at 23° C. and 50% RH.

Both the shrinkage ratio in the longitudinal direction (MD direction) and that in the width direction (TD direction) of the stretched film are 1.5% or less, preferably 1.3% or less, when the stretched film is left to stand in an atmosphere at 85° C. and 85% RH for 120 hours. When the shrinkage ratio is 1.5% or less, it is possible to inhibit lowering of contrasts and vicinity unevenness of the liquid crystal display device when the stretched film is adhered to the polarizer. On the other hand, the lower limit of the shrinkage ratio is not particularly limited, and the shrinkage ratio may be, for example, 0.1% or more in both the longitudinal direction (MD direction) and the widthwise direction (TD direction) of the stretched film. In the case that the shrinkage ratio of the stretched film is 0.1% or more, even when a polarizer to which the stretched film is adhered shrinks itself, the stretched film easily follows the shrinkage. The shrinkage ratio when a stretched film is left to stand in an atmosphere at 85° C. and 85% RH for 120 hours can be determined by measuring the dimensional change before and after the stretched film is left to stand in an environmental tester set at 85° C. and 85% RH for 120 hours, using a three-dimensional measuring instrument.

The peel strength in both the longitudinal direction (MD direction) and the width direction (TD direction) of the stretched film is 1.0 N/cm or more, preferably 1.2 N/cm or more. A peel strength of 1.0 N/cm or more is excellent in re-workability and durability after being bonded to polarizers. The peel strength can be determined by measuring with an autograph and averaging data between 10 mm and 60 mm of the obtained measurement data.

As the instant adhesive, commercially available instant adhesives can be used. The commercially available instant adhesives include the trade name “Aron Alpha Series” manufactured by Toagosei Co., Ltd. (Aron Alpha® for Professional No. 1, Aron Alpha® Immediate Effective Multipurpose Extra, Aron Alpha® for Plastics, etc.).

As the polycarbonate film, commercially available polycarbonate films can be used as they are. Examples of the commercially available polycarbonate films include the trade name “Pure Ace Series®” manufactured by TEIJIN LIMITED and the trade name “Elmech Series®” (R140 and R435, etc.) manufactured by KANEKA CORPORATION.

In this regard, in order to improve mechanical properties of stretched films, acrylic thermoplastic elastomers as well as acrylic rubber particle (B) are considered. However, as a result of the research by the present inventors, when an acrylic thermoplastic elastomer is used, the acrylic thermoplastic elastomer is often in a dispersed form in which the acrylic thermoplastic elastomer extends from a disk-like shape to a rod-like shape in film-forming film, and accordingly the following problem may occur: the interface with acrylic resin having a glass transition temperature of 120° C. or more (A) is increased, and the interface breakage of acrylic resin having a glass transition temperature of 120° C. or more (A) and the acrylic thermoplastic elastomer is liable to occur; as a result, the peel strength is lowered, and when the film is cut after being bonded to the polarizer, cracking or chipping of edge portions may occur. When acrylic rubber particle (B) of the present invention is used, the dispersed form is closer to a spherical shape than when a thermoplastic elastomer is used, enabling the interfacial area with acrylic resin having a glass transition temperature of 120° C. or more (A) to be suppressed to a smaller value, thereby solving the above-mentioned problems. In particular, when the stretching temperature is set to a high temperature, orientation is suppressed, and dispersed shape of acrylic rubber particle (B) can be made closer to a spherical shape, which is preferable.

The stretched film of the present invention can be provided with an easy adhesive layer on one surface or each of both surfaces of the film. When a stretched film used, for instance, as a polarizer protective film is bonded to a polarizer via an adhesive, providing an easy adhesion layer can reinforce adhesion between the polarizer protective film and the polarizer. It is also possible to obtain a stretched film having an easy adhesive layer by providing an unstretched film with an easy adhesive layer, followed by stretching.

The easy adhesive layer used in the present invention can be formed by using a known technique disclosed in Japanese Unexamined Patent Application, Publication Nos. 2009-193061 and 2010-55062. That is, for example, it can be formed of an easy adhesive composition containing a urethane resin having a carboxyl group and a crosslinking agent. An easy adhesive layer having excellent adhesion between the polarizer protective film and the polarizer can be obtained by using the urethane resin. The easy adhesive composition is preferably water-borne from the viewpoint of its workability and environmental protection.

The internal haze of the stretched film of the present invention is preferably 1.0% or less. More preferably, it is 0.5% or less, and even more preferably 0.3% or less. An internal haze lower than 1.0% improves quality when mounted on the liquid crystal panel.

The stretched film has an improved MIT double fold number until the stretched film is broken in the MIT folding endurance test (hereinafter, also referred to “fold number”). The fold number is preferably 350 counts or more, preferably 500 counts or more, in both the longitudinal direction (MD direction) and the width direction (TD direction) of the stretched film. When the fold number of film is 350 counts or more, the film is preferred from the viewpoint of risk of breakage due to the long film forming process or re-workability after the stretched film is bonded to liquid crystal panels. Uniaxial stretching or biaxial stretching in the stretched film according to the present invention may be optionally carried out. However, biaxial stretching can increase the MIT double fold number until the stretched film is broken in the MIT bending endurance test.

The MIT double fold number of 350 counts or more can be achieved in the MIT bending endurance test using a film made of an acrylic resin containing no acrylic rubber particle (B), depending on the processing method such as stretching conditions. However, the stretching condition at that time is in the direction of decreasing a stretching temperature or in the direction of increasing stretching ratio, so that breakage risk in the stretching process is increased. According to the present invention, it is possible to achieve the fold number in the MIT bending endurance test of 350 counts or more, to obtain a stretched film having a low risk of breakage during the stretching and a small dimensional change, to suppress a decrease in peel strength when the stretched film is bonded to a polarizer, and to obtain a polarizer protective film using an acrylic resin composition having good transparency, due to the effect of acrylic rubber particle (B) even when the stretching temperature is relatively high.

The MIT folding endurance test here is carried out by using an MIT folding-resistance fatigue tester and a strip-shaped test piece having a width of 15 mm. The double fold number is defined as the number of counts that a stretched film can be folded before the stretched film is broken under the conditions of radius of curvature R of folding clamp: 0.38 mm; folding angle in the right and left sides: 135°; folding speed: 175 counts/min.; and load: 1.96 N.

The glass transition temperature of the stretched film of the present invention is 110° C. or more, preferably 115° C. or more, more preferably 120° C. or more. The glass transition temperature here is measured by using 10 mg of an acrylic resin or an acrylic resin composition and a differential scanning calorimeter in a nitrogen-atmosphere at a heating rate of 20° C./min., and determined by the midpoint method.

The average refractive index of the inventive acrylic resin having a glass transition temperature of 120° C. or more (A) is preferably 1.48 or more. It is also preferable that the refractive index difference between acrylic resin having a glass transition temperature of 120° C. or more (A) and acrylic rubber particle (B) be 0.02 or less, more preferably 0.01 or less. Since acrylic rubber particle (B) is dispersed in acrylic resin (A), the smaller the refractive index difference between acrylic resin (A) and acrylic rubber particle (B), the lower the haze difference in the stretched film tends to be. The average refraction index of the stretched film here can be measured, for example, by using an Abbe Refractometer.

The internal haze here is defined as a haze value measured using a haze meter (turbidity meter) for glass cells for liquid measurement, in which an obtained film is put and pure water is filled around the film.

(Acrylic Resin having a Glass Transition Temperature of 120° C. or More (A))

In the present invention, acrylic resin having a glass transition temperature of 120° C. or more (A) is used. Acrylic resin having a glass transition temperature of 120° C. or more (A) may increase a glass transition temperature of a stretched film comprising acrylic resin having a glass transition temperature of 120° C. or more (A) and acrylic rubber particle (B), providing the stretched film, for instance, with a smaller dimensional change rate. In practical use, the stretched film of the present invention is often used as a laminate film with other films. Therefore, a small dimensional change rate can suppress distortion or warp arising from difference in dimensional change rates generated between the stretched film and the other laminated films.

Here, as acrylic resin having a glass transition temperature of 120° C. or more (A), an acrylic resin having a ring structure in a main chain may be preferably used. For instance, examples of the ring structure include at least one selected from the group consisting of a glutarimide ring, a lactone ring, maleic anhydride, maleimide and glutaric anhydride. It is possible to render the stretched film having heat resistance. Among the above, matter that the ring structure is glutarimide is particularly preferable from the viewpoint of convenient production, cost or stable product quality against moisture.

Examples of acrylic resin having a glass transition temperature of 120° C. or more (A) include a process of introducing a carboxyl group of methacrylic acid. It is preferable to suppress a content of carboxyl group to a given amount or less, since an increase in the content of carboxyl group of a given amount or more results in a risk of formation of a crosslinked product, or increases a risk of foaming during the film formation. Specifically, the content of carboxyl group in the acrylic resin is 0.6 mmol/g or less, preferably 0.4 mmol/g.

The content of the ring structure in the acrylic resin having a glass transition temperature of 120° C. or more is preferably 2% by weight to 80% by weight. This range of ring structure content is preferred, because both glass transition temperature and phase difference in thickness direction Rth are excellent. The ring structure content in the acrylic resin was calculated by measuring molar ratio of the ring structure portion, which is a target, and a portion other than the above using ¹H-NMR, followed by weight conversion.

The respective ring structures are explained below.

(Acrylic Resin having Glutarimide Ring)

The acrylic resin having a glutarimide ring as the ring structure is a resin having a glutarimide unit represented by general formula (1) and a methyl methacrylate unit, and can be obtained by heat melting an acrylic resin having an acrylate unit in a content of less than 1% by weight, followed by treatment with an imidization agent.

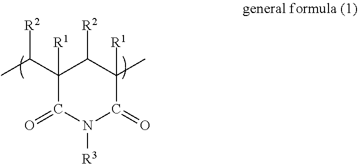

wherein R¹ and R² each independently represent a hydrogen atom or an alkyl group having 1 to 8 carbon atoms, and R³ represents an alkyl group having 1 to 18 carbon atoms, a cycloalkyl group having 3 to 12 carbon atoms or an aryl group having 6 to 10 carbon atoms.

The content of glutarimide ring according to the present invention is a value which can be measured, for instance, by the following method. The measurement is carried out using ¹H-NMR. Weight conversion is carried out by using the molar ratio obtained from a peak area derived from protons of O—CH, of methyl methacrylate around 3.5 ppm to 3.8 ppm and a peak area derived from protons of N—R³ of glutarimide group around 3.0 ppm to 3.3 ppm.

In the step of treating with the imidization agent, for instance, methyl acrylate, ethyl (meth)acrylate, butyl (meth)acrylate, isobutyl (meth)acrylate, t-butyl (meth)acrylate, benzyl (meth)acrylate, and cyclohexyl (meth)acrylate may be used in combination, other than methyl methacrylate. When these are used in combination, the content of acrylic acid ester unit is preferably less than 1% by weight. Moreover, the content of acrylic acid ester unit is less than 0.5% by weight, and more preferably less than 0.3% by weight.

Other than the above-mentioned monomers, it is possible to copolymerize a nitrile-based monomer, such as acrylonitrile and methacrylonitrile, a maleimide-based monomer such as maleimide, N-methyl maleimide, N-phenylmaleimide, and N-cyclohexyl maleimide, and an aromatic vinyl-based monomer such as styrene.

The structure of the methyl methacrylate resin is not particularly limited, and may be any of a linear (chain-like) polymer, a block polymer a core-shell polymer, a branched polymer, a ladder polymer, a crosslinked polymer and the like.

In the case of block copolymer, the structure may be any of an A-B type, an A-B-C type, an A-B-A type and a block polymer other than these. In the case of core-shell polymer, the core-shell polymer may comprise a core formed of only one layer and a shell formed of only one layer or both the core and the shell are formed of multiple layers.

The method of manufacturing methyl polymethacrylate is not particularly limited, and known polymerization methods, such as emulsion polymerization, emulsion-suspension polymerization, suspension polymerization, mass polymerization and solution polymerization, are applicable. For use in the optical field, mass polymerization and solution polymerization are particularly preferable from the viewpoint of small amount of impurities. Methyl polymethacrylate can be manufactured, for instance, according to methods disclosed in Japanese Unexamined Patent Application, Publication No. S56-8404, Japanese Examined Patent Application, Publication No. H6-86492, H7-37482 or S52-32665, or the like.

The present invention includes a step of heat melting a methyl methacrylate resin or an acrylic resin obtained by copolymerizing a monomer other than the methyl methacrylate monomer, followed by treatment with an imidization agent (imidization step). This step enables manufacturing of an acrylic resin having a glutarimide.

The imidization agent is not particularly limited, so long as the imidization agent can produce a glutarimide ring represented by general formula (1), and those disclosed in WO2005/054311 may be mentioned. Specifically, examples of the imidization agent include ammonia; aliphatic hydrocarbon group-containing amines such as methylamine, n-propylamine, propyl amine, n-butylamine, i-butylamine, tert-butylamine and n-hexylamine; aromatic hydrocarbon group-containing amines such as aniline, benzylamine, toluidine, and trichloroaniline; and alicyclic hydrocarbon-containing amines such as cyclohexylamine. It is also possible to use a urea-based compound generating the exemplified amines by heating, such as 1,3-dimethylurea, 1,3-diethylurea and 1,3-dipropylurea. Among these imidization agents, it is preferred to use methylamine, ammonia and cyclohexylamine, and particularly preferred to use methylamine, from the viewpoint of both cost and physical properties.

Methylamine and the like, which are gaseous at an ambient temperature, may be used in a state of being dissolved in an alcohol, such as methanol.

Adjusting an addition ratio of the imidization agent in this imidization step allows to control a ratio of a glutarimide unit and a (meth)acrylate unit in the obtained acrylic resin.

Additionally, adjusting the degree of imidization allows to control physical properties of the obtained acrylic resin or optical characteristics of the stretched film formed by molding the acrylic resin according to the present invention.

The amount of an imidization agent is preferably 0.5 parts by weight to 20 parts by weight relative to 100 parts by weight of acrylic resin including a methyl methacrylate unit. When the addition amount of the imidization agent is within this range, the imidization agent does not easily remain in the resin and possibility that defects in appearance or foaming after molding is induced is very low. Moreover, since the content of glutarimide ring in the resin composition finally obtained also becomes appropriate, the heat resistance does not easily decrease and defects in appearance after molding are not easily induced, which is preferable.

In this imidization step, a ring-closing promoter (catalyst) may be added, as required, in addition to the imidization agent.

The method of heat melting and treating with an imidization agent is not particularly limited and any conventionally known method may be used. For instance, the acrylic resin comprising a methyl methacrylate unit may be imidated by methods using an extruder or a batch-type reactor (pressure vessel).

The extruder is not particularly limited. For instance, a single screw extruder, a twin-screw extruder, a multi-screw extruder or the like may be used. The above-mentioned extruders may be used singly or two or more extruders may be connected in series and used. When a twin-screw extruder is used, examples of the twin-screw extruder include a non-intermeshing co-rotating twin-screw extruder, an intermeshing co-rotating twin-screw extruder, a non-intermeshing counter-rotating twin-screw extruder and an intermeshing counter-rotating twin-screw extruder. Among them, the intermeshing co-rotating twin-screw extruder can rotate at high speed, and therefore mixing of a raw material polymer with an imidization agent (or, when a ring-closing promoter is used, mixing of the imidization agent with the ring-closing promoter) can be further promoted, which is preferred.

When the imidization is carried out in an extruder, for instance, a methyl methacrylate resin is fed from a raw material input member of the extruder, the resin is melted, a cylinder is filled with the resin, and then the imidization agent is put into the extruder using an addition pump, so that the imidization can be proceeded in the extruder.

In this case, temperatures (resin temperatures), duration times (reaction times), and resin pressures, during the treatment in the extruder, are not particularly limited as long as glutar-imidization is possible.

When an extruder is used, a vent hole possible of reducing the pressure to below atmospheric pressure is preferably installed in order to remove unreacted imidization agent and by-products. According to such a configuration, unreacted imidization agents, byproducts such as methanol, and monomers can be removed.

When a glutarimide ring-containing acrylic resin is produced using a batch reactor (pressure vessel), the structure of the batch reactor (pressure vessel) is not particularly limited. It is sufficient to have a structure that can melt and stir a methyl methacrylate unit-containing acrylic resin by heating and to add an imidization agent (if a ring-closing promotor is used, the imidization agent and the ring-closing promotor) and it is preferable to have a structure that can provide good stirring efficiencies.

Examples of the imidization method include known methods disclosed, for instance, in Japanese Unexamined Patent Application, Publication No. 2008-273140 or 2008-274187.

The production method of the present invention may include, in addition to the above-described imidization step, an esterification step in which treatment using an esterification agent is performed. This esterification step makes it possible to adjust the acid value of the imidated resin obtained in the imidization step to a value within a desired range.

The esterification agent is not particularly limited, so long as the esterification agent can esterify carboxyl groups remaining in molecular chains. Examples thereof include dimethyl carbonate, 2,2-dimethoxypropane, dimethylsulfoxide, triethyl orthoformate, trimethyl orthoacetate, trimethyl orthoformate, diphenyl carbonate, dimethyl sulfate, methyl toluenesulfonate, methyl trifluoromethylsulfonate, methyl acetate, methanol, ethanol, methyl isocyanate, p-chlorophenyl isocyanate, dimethylcarbodiimide, dimethyl-t-butylsilylchloride, isopropenyl acetate, dimethylurea, tetramethylammonium hydroxide, dimethyl diethoxysilane, tetra-N-butoxysilane, dimethyl(trimethylsilane) phosphite, trimethyl phosphite, trimethyl phosphate, tricresyl phosphate, diazomethane, ethylene oxide, propylene oxide, cyclohexene oxide, 2-ethylhexylglycidyl ether, phenyl glycidyl ether, and benzyl glycidyl ether. Among them, dimethyl carbonate and trimethyl orthoacetate are preferable from the viewpoint of cost, reactivity, and the like. From the viewpoint of cost, dimethyl carbonate is preferable.

In this imidization step, the amount of the esterification agent is preferably 0 to 30 parts by weight, and more preferably 0 to 15 parts by weight, with regard to 100 parts by weight of the methyl methacrylate unit-containing acrylic resin. The esterification agent can adjust an acid value to an appropriate range, so long as the amount of the esterification agent is within these ranges. On the other hand, if the amount of the esterification agent is more than the above range, there is a possibility that the unreacted esterification agent remains in the resin, in which case the unreacted esterification agent may become a cause of foaming or odor generation when molding is performed using the obtained resin.

A catalyst may be used in addition to the esterification agent. The type of catalyst is not particularly limited, so long as the catalyst can accelerate esterification. Examples of the catalyst include aliphatic tertiary amines such as trimethylamine, triethylamine, and tributylamine. Among them, triethylamine is preferred from the viewpoint of cost, reactivity and the like.

This esterification step may be performed only by heat treatment without treating with the esterification agent. When only the heat treatment (kneading and dispersing the melted resin in the extruder) is conducted, some or all of carboxyl groups can be converted to acid anhydride groups by, for example, a dehydration reaction between carboxyl groups or a dealcoholization reaction between a carboxyl group and an alkyl ester group in the acrylic resin having a glutarimide ring produced as a by-product in the imidization step. At this time, a ring-closing promoter (catalyst) may be used.

Even when the esterification step is performed using the esterification agent, conversion to acid anhydride groups by heat treatment can be allowed to proceed in parallel.

The imide resin after having undergone the imidization step and the esterification step contains an unreacted imidization agent or an unreacted esterification agent, or a volatile component produced as a by-product in the reaction and a degradation product of the resin and the like. Therefore, it is possible to provide a vent port, so that the pressure can be reduced to atmospheric pressure or less.

### (Acrylic Resin Having a Lactone Ring)

The acrylic resin having a lactone ring as the ring structure is not particularly limited, so long as the acrylic resin having a lactone ring is a thermoplastic polymer having a lactone ring structure in the molecule (a thermoplastic polymer which has a lactone ring structure introduced into its molecular chain). Although the production method thereof is also not limited, the acrylic resin having a lactone ring can be preferably obtained by obtaining a polymer having a hydroxyl group and an ester group (a) by polymerization (polymerization step), and then subjecting the obtained polymer (a) to heat treatment and thereby introducing a lactone structure into the polymer (lactone cyclization condensation step).

In the polymerization step, a monomer component containing an unsaturated monomer represented by the following general formula (2) is polymerized and thereby a polymer having a hydroxyl group and an ester group in the molecular chain is obtained.

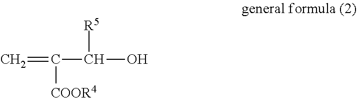

wherein R⁴ and R⁵ each are independently a hydrogen atom or an alkyl group having 1 to 20 carbon atoms.

As the unsaturated monomer represented by general formula (2), examples include methyl 2-(hydroxymethyl) acrylate, ethyl 2-(hydroxymethyl) acrylate, isopropyl 2-(hydroxymethyl) acrylate, n-butyl 2-(hydroxymethyl) acrylate and tert-butyl 2-(hydroxymethyl) acrylate. Among the above, methyl 2-(hydroxymethyl) acrylate and ethyl 2-(hydroxymethyl) acrylate are preferred and from the viewpoint of high improvement in heat resistance, methyl 2-(hydroxymethyl) acrylate is particularly preferred. These unsaturated monomers may be used singly or in combination of two or more.

The content of the unsaturated monomer represented by general formula (2) in monomer components is preferably 5% by weight to 50° by weight, more preferably 10° by weight to 40° by weight, even more preferably 10% by weight to 30% by weight. When the content is less than 5% by weight, there is possibility that heat resistance, solvent resistance and surface hardness of the obtained lactone-containing polymer are lowered. When the content is more than 50° by weight, crosslinking reaction takes place during the lactone ring structure formation and gelation easily occurs. This results in lowered fluidity and difficulty in melt molding. Further, unreacted hydroxy groups tend to remain and condensation further proceeds during molding to generate a volatile substance. This may result in easy generation of silver streaks or an increase in the thickness direction phase difference Rth.

The monomer component preferably includes a monomer other than the unsaturated monomer represented by general formula (2). The other monomer is not particularly limited, so long as it is selected in the scope that the effect of the present invention is not hampered, and examples of the other monomer preferably include (meth)acrylic acid esters, hydroxyl group-containing monomers, unsaturated carboxylic acids and unsaturated monomers represented by the following general formula (3). The other monomer may be used singly or in combination of two or more.

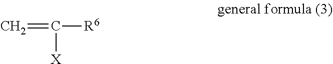

wherein R⁶ represents a hydrogen atom or a methyl group, X represents a hydrogen atom, an alkyl group having 1 to 20 carbon atoms, an aryl group, an OAc group, a —CN group, a —CO—R⁷ group or a —C—O—R⁸ group and R⁷ and R⁸ represent a hydrogen atom or an alkyl group having 1 to 20 carbon atoms.

The (meth)acrylic acid ester is not particularly limited, so long as it is a (meth)acrylic acid ester other than the unsaturated monomer represented by general formula (2). Examples thereof include acrylic acid esters, such as methyl acrylate, ethyl acrylate, n-butyl acrylate, isobutyl acrylate, t-butyl acrylate, cyclohexyl acrylate and benzyl acrylate; and methacrylic acid esters such as methyl methacrylate, ethyl methacrylate, isopropyl methacrylate, n-butyl methacrylate, isobutyl methacrylate, t-butyl methacrylate, cyclohexyl methacrylate and benzyl methacrylate. These may be used singly or in combination of two or more. Among the above, methyl methacrylate is preferred from heat resistance and transparency.

When the (meth)acrylic acid ester is used, the content thereof in the monomer components is preferably 10° by weight to 95% by weight, more preferably 10% by weight to 90% by weight, even more preferably 40° by weight to 90% by weight, and particularly preferably 50% by weight to 90% by weight, to sufficiently achieve the effects of the present invention.

### (Acrylic Resin Having Maleic Anhydride Structure, Maleimide

Structure or Anhydrous Glurtaric Acid Structure) It is also preferable to use acrylic resin having a maleimide structure or a glutaric anhydride structure as the ring structure. Examples of the maleic anhydride structure include a copolymer of styrene-N-phenylmaleimide-maleic anhydride. Examples of the maleimide structure include olefin/maleimide copolymers disclosed in Japanese Unexamined Patent Application, Publication No. 2004-45893. Examples of the glutaric anhydride structure include copolymers having a glutaric anhydride unit, disclosed in Japanese Unexamined Patent Application, Publication No. 2003-137937.

### (Acrylic Rubber Particle (B))

As the acrylic rubber particle, preferred is a core-shell type elastic body having a core layer comprising a rubber-like polymer and a shell layer comprising a glass-like polymer (also referred to as hard polymer). Tg of the rubber-like polymer constituting the core layer is preferably 20° C. or less, more preferably −60° C. to 20° C., and even more preferably −60° C. to 10° C. When the Tg of the rubber-like polymer constituting the core layer is higher than 20° C., there is possibility that improvement in mechanical properties of the acrylic resin composition is insufficient. The Tg of the glass-like polymer (hard polymer) constituting the shell layer is preferably 50° C. or more, more preferably 50° C. to 140° C., and even more preferably 60° C. to 130° C. When the Tg of the glass-like polymer constituting the shell layer is lower than 50° C., there is possibility that heat resistance of the acrylic resin composition is lowered.

The content of the core layer in the core-shell type elastic body is preferably 30% by weight to 95% by weight, more preferably 50% by weight to 90% by weight. The content of the shell layer in the core-shell type elastic body is preferably 5% by weight to 70% by weight, more preferably 10% by weight to 50% by weight. The core-shell type elastic body of the present invention may contain any other suitable component, in a range that the effects of the present invention are not hampered.

As a polymerizable monomer to form the rubber-like polymer constituting the core layer, any suitable polymerizable monomer may be used. The polymerizable monomer to form the rubber-like polymer preferably comprises (meth)acrylic acid esters. The (meth) acrylic acid ester is preferably contained in a content of 50% by weight or more, more preferably in a content of 50% by weight to 99.9% by weight, and even more preferably in a content of 60% by weight to 99.9% by weight in 100% by weight of the polymerizable monomer to form the rubber-like polymer.

Examples of the (meth)acrylic acid esters include (meth)acrylic acid esters in which the alkyl group has 2 to 20 carbon atoms, such as ethyl (meth)acrylate, propyl (meth)acrylate, butyl (meth)acrylate, cyclohexyl (meth)acrylate, 2-ethylhexyl (meth)acrylate, isononyl (meth)acrylate, lauroyl (meth)acrylate and stearyl (meth)acrylate. Among these, (meth)acrylic acid esters in which the alkyl group has 2 to 10 carbon atoms, such as butyl (meth)acrylate, 2-ethylhexyl (meth)acrylate and isononyl (meth)acrylate, are preferred, and butyl acrylate, 2-ethylhexyl acrylate and isononyl acrylate are more preferred. These may be used singly or in combination of two or more.

The polymerizable monomer to form a rubber-like polymer preferably contains a multi-functional monomer having two or more vinyl groups in the molecule. The multi-functional monomer having two or more vinyl groups in the molecule is preferably contained in the polymerizable monomer to form the rubber-like polymer, in a content of 0.01° by weight to 20° by weight, more preferably 0.1% by weight to 20% by weight, even more preferably 0.1% by weight to 10% by weight, and particularly preferably 0.2% by weight to 5% by weight.

Examples of the multi-functional monomer having two or more vinyl groups in the molecule include aromatic divinyl monomers such as divinyl benzene; poly(meth)acrylic acid alkane polyol such as ethylene di(meth)acrylate, butylene di(meth)acrylate, hexylene di(meth)acrylate, oligoethylene di(meth)acrylate, trimethylolpropane di(meth)acrylate and trimethylolpropane tri(meth)acrylate; urethane di(meth)acrylate; and epoxy di(meth)acrylate. Examples of the multi-functional monomer having vinyl groups having different reactivities include allyl (meth) acrylate, diallyl maleate, diallyl fumarate, and diallyl itaconate. Among these, ethylene dimethacrylate, butylene diacrylate, and allyl methacrylate are preferable. These may be used singly or in combination of two or more.

The polymerizable monomer to form a rubber-like polymer may include (meth)acrylic acid esters as described above and another polymerizable monomer copolymerizable with a multi-functional monomer having two or more vinyl groups in the molecule. The other polymerizable monomer is preferably contained in a content of 0% to 49.9% by weight, more preferably in a content of 0% to 39.9% by weight in the polymerizable monomer to form a rubber-like polymer.

Examples of the other polymerizable monomer include aromatic vinyl and aromatic vinylidene such as styrene, vinyltoluene and a-methylstyrene; vinyl cyanides and vinylidene cyanides such as acrylonitrile and methacrylonitrile; methyl methacrylate; urethane acrylate; and urethane methacrylate. The other polymerizable monomer may be a monomer having a functional group such as an epoxy group, a carboxyl group, a hydroxyl group, or an amino group. Specifically, examples of the monomer having an epoxy group include glycidyl methacrylate, and examples of the monomer having a carboxyl group include methacrylic acid, acrylic acid, maleic acid and itaconic acid. Examples of the monomer having a hydroxyl group include 2-hydroxyethyl methacrylate and 2-hydroxyethyl acrylate. Examples of the monomer having an amino group include diethylaminoethyl (meth)acrylate. These may be used singly or in combination of two or more.

As the polymerizable monomer to form a glass-like polymer constituting a shell layer, any suitable polymerizable monomer may be used.

The polymerizable monomer to form a glass-like polymer preferably includes at least one monomer selected from (meth)acrylic acid esters and aromatic vinyl monomers. At least one selected from (meth)acrylic acid esters and aromatic vinyl monomers is preferably contained in a content of 50° by weight to 100% by weight, and more preferably contained in a content of 60% by weight to 100% by weight, in 100% by weight of the polymerizable monomer to form a glass-like polymer.

As the (meth)acrylic acid ester, those in which the alkyl group has 1 to 4 carbon atoms is preferable, such as (meth)methyl acrylate and ethyl (meth) acrylate, and methyl methacrylate is more preferable. These may be used singly or in combination of two or more.

Examples of the aromatic vinyl monomer include styrene, vinyltoluene, a-methylstyrene, and styrene is preferable among these. These may be used singly or in combination of two or more.

The polymerizable monomer to form a glass-like polymer may include a multi-functional monomer having two or more vinyl groups in the molecule. The multi-functional monomer having two or more vinyl groups in the molecule is contained preferably in a content of 0% by weight to 10% by weight, more preferably in a content of 0% by weight to 8% by weight, and even more preferably in a content of 0% by weight to 5% by weight in 100% by weight of the polymerizable monomer to form a glass-like polymer.

Examples of the multi-functional monomer having two or more vinyl groups in the molecule include those described above.

The polymerizable monomer to form a glass-like polymer may include (meth)acrylic acid esters as described above and another polymerizable monomer copolymerizable with a multi-functional monomer having two or more vinyl groups in the molecule. The other polymerizable monomer is preferably contained in a content of 0% to 50% by weight, and more preferably contained in a content of 0% to 40% by weight, in 100% by weight of the polymerizable monomer to form a glass-like polymer.

Examples of the other polymerizable monomer include vinyl cyanides and vinylidene cyanides, such as acrylonitrile and methacrylonitrile; (meth)acrylic acid esters other than those described above; urethane acrylate; and urethane methacrylate. In addition, examples of the other polymerizable monomer may include those having a functional group such as an epoxy group, a carboxyl group, a hydroxyl group, or an amino group. Examples of the monomer having an epoxy group include glycidyl methacrylate; examples of the monomer having a carboxyl group include methacrylic acid, acrylic acid, maleic acid and itaconic acid; examples of the monomer having a hydroxyl group include 2-hydroxymethacrylate and 2-hydroxyacrylate; and examples of the monomer having an amino group include diethylaminoethyl methacrylate and diethylaminoethyl acrylate. These may be used singly or in combination of two or more.

As a method for producing the core-shell type elastic body, any appropriate method capable of producing core-shell type particles can be employed.

For example, a suspension or emulsion dispersion containing rubber-like polymer particles is produced by suspension or emulsion polymerization of a polymerizable monomer to form a rubber-like polymer to constitute a core layer, and successively a polymerizable monomer to form a glass-like polymer to constitute a shell layer is added to the suspension or emulsion dispersion to perform radical polymerization to obtain a core-shell type elastic body having a multi-layered structure in which the surfaces of rubber-like polymer particles are coated with a glass-like polymer. Here, the polymerizable monomer to form a rubber-like polymer and the polymerizable monomer to form a glass-like polymer can be polymerized in one stage, or at least two stages by changing the compositional ratio.

The shape of dispersed acrylic rubber particle (B) in the acrylic resin composition constituting the stretched film of the present inventions is not particularly limited, but may be spherical, flat, or disc-shaped depending on the molding method or the stretching method. There is no particular limitation on the diameter of the dispersed particles, but in any dispersion shape, the average dispersion length in both the major axis direction and the minor axis direction is preferably from 10 nm to 500 nm, more preferably from 100 nm to 400 nm, and even more preferably from 150 nm to 300 nm. When the average dispersion length is 10 nm or less, the glass transition temperature of the acrylic resin composition tends to decrease. If the average dispersion length exceeds 500 nm, the dispersion state becomes ununiform, the haze tends to increase, and the peel strength and the MIT double fold number tend to decrease.

The average dispersion length of acrylic rubber particle (B) described above is typically measured visually using transmission electron microscopy (TEM).

In order to ensure balanced physical properties of the acrylic film of the present invention, it is desirable to appropriately control the structure of the core-shell type elastic body.

Preferable structures of the core-shell type elastic body include, for example, (a) a structure in which the core-shell type elastic body has a soft inner layer and a hard outer layer, with the inner layer comprising a crosslinked (meth)acrylic polymer layer and (b) a structure in which the core-shell type elastic body has a hard inner layer, a soft intermediate layer and a hard outer layer, with the inner layer comprising at least one hard polymer layer, and with the intermediate layer comprising a soft polymer comprising a crosslinked (meth)acrylic polymer layer. It is possible to arbitrarily control physical properties (mechanical properties, optical properties, oriented birefringence, and photoelastic coefficient) of acrylic resin compositions by appropriately selecting monomer species of each layer. The term “soft” preferably means that the glass transition temperature of the polymer is less than 20° C., and the term “hard” preferably means that the glass transition temperature of the polymer is 20° C. or more.

Examples of more preferred structures of the core-shell type elastic body include: (i) a structure in which the shell layer of the multi-layer structure particle is formed of a non-crosslinked methacrylic resin containing 0.1% by weight or more, more preferably 1% by weight or more, of acrylic acid ester; (ii) a structure in which the shell layer of the multi-layer structure particle is formed of multiple layers of two layers or more, with each layer having a different acrylic acid ester content, and the shell layer is formed of a non-crosslinked methacrylic resin containing 1% by weight or more of acrylic acid ester in total; and (iii) a structure in which the core layer of the multi-layer structure particle has a multi-layer structure, in which an intermediate layer is formed by copolymerizing an acrylic acid ester, a multi-functional monomer, and another appropriate monomer using a peracid (persulfate, a perphosphate salt, etc.) as a pyrolysis type initiator, in the presence of a latex of innermost layer particles comprising a crosslinked methacrylic resin obtained by polymerization using an organic peroxide as a redox type initiator. Such a structure allows the core-shell type elastic body in the acrylic resin composition of the present invention to be easily dispersed in a satisfactory manner, and when a film is formed, it is possible to obtain a film in which defects due to undispersed core-shell type elastic body and agglomeration are reduced, strength, toughness, heat resistance, transparency, and appearance are excellent, whitening due to temperature change and stress is suppressed, and quality is excellent.

### (Acrylic Resin Composition)

The content of the acrylic rubber particles is preferably from 1% to 50% by weight, more preferably from 2% to 35% by weight, even more preferably from 3% to 25% by weight, relative to the acrylic resin composition constituting the stretched film of the present invention. When the content of the acrylic rubber particles is less than 1% by weight, the mechanical properties of the acrylic resin composition are not sufficiently improved, and when it is more than 50% by weight, the heat resistance of the acrylic resin composition may be lowered or haze may be deteriorated. [0119]

The glass transition temperature of the acrylic resin composition constituting the stretched film of the present invention is preferably 115° C. or more, and more preferably 120° C. or more. The glass transition temperature here is a value obtained by measuring using a differential scanning calorimeter (DSC, manufactured by SII, DSC7020) in a nitrogen-atmosphere at a heating rate of 20° C./min, and analyzing by the midpoint method. When the glass transition temperature is 115° C. or more, dimensional change is small when laminated as a film constituting a liquid crystal panel typified by the polarizer protective film; warp of the laminated film due to the dimensional change is small; and the phase-difference change is small, so that problems in practical use are less likely to occur.

To the acrylic resin compositions, the following agents may be added as required: generally used antioxidants, thermal stabilizers, light resistance stabilizers such as light stabilizers, ultraviolet absorbers, specific wavelength absorbers or specific wavelength absorbing dyes for the purpose of blue light cutting and radical scavengers, phase difference adjusting agents, catalysts, plasticizers, lubricants, antistatic agents, colorants, shrinkage inhibitors, antibacterial agents/deodorants, fluorescent brighteners and compatibilizers. Generally, these may be added singly or in combination of two or more, as long as the object of the present invention is not impaired.

Examples of the ultraviolet absorbers include triazine-based compounds, benzotriazole-based compounds, benzophenone-based compounds, cyanoacrylate-based compounds, benzoxazine-based compounds and oxadiazole-based compounds. Among these, from the viewpoint of ultraviolet absorption performance with respect to an added amount or volatility when melt extrusion is performed, the triazine compounds are preferable.

With regard to the phase difference adjusting agent, when a negative phase difference is to be imparted, for example, it is sufficient only if the difference adjusting agent has a styrene skeleton, and an acrylonitrile-styrene copolymer can be exemplified.

Methods for mixing acrylic resin (A) with acrylic rubber particle (B) are not particularly limited, and any known method can be used. Examples of the method include a method of melt-kneading by feeding to an extruder using a gravimetric feeder, or a method of preparing a solution of acrylic resin (A) and acrylic rubber particle (B) by mixing with a solvent having excellent compatibility with both.

When mixing is performed using an extruder, the extruder used is not particularly limited, and various extruders can be used. Specifically, it is possible to use a mono-screw extruder, a twin-screw extruder or a multi-screw extruder. Inter alia, it is preferable to use a twin-screw extruder. The two-axis extruder provides a high degree of freedom of conditions in uniformly mixing acrylic resin (A) and acrylic rubber particle (B). In addition, acrylic resin (A) and acrylic rubber particle (B) may be fed from the upstream side of the extruder using a material feeding hopper or the like and mixed, or acrylic rubber particle (B) alone may be fed from the middle of the extruder using a side feeder, a gravitational feeder or the like and mixed.

A filter may be installed at the end of the extruder to reduce foreign matter in the resin, in the state of acrylic resin (A) prior to being mixed with acrylic rubber particle (B) and/or in the state that acrylic resin (A) and acrylic rubber particle (B) are mixed with each other, in the present invention. It is preferable to install a gear pump upstream of the filter to increase the pressure of the acrylic resin (A)/acrylic resin composition. As the type of the filter, it is preferable to use a leaf disk filter made of stainless steel capable of removing foreign matter from a molten polymer, and as the filter element, it is preferable to use a fiber type, a powder type, or a composite type thereof.

### (Method for Producing Stretched Film)

An embodiment of the method for producing the stretched film of the present invention is described, but the present invention is not limited thereto. That is, any conventionally known method can be used as long as a film can be produced by molding the acrylic resin composition of the present invention.

Examples include injection molding, melt extrusion molding, inflation molding, blow molding and compression molding. In addition, the film according to the present invention can be produced by a solvent casting method or a spin-coating method, in which the acrylic resin composition according to the present invention is dissolved in a dissolvable solvent, followed by molding.

Inter alia, it is preferable to use the melt extrusion method that does not use a solvent. The melt extrusion method can reduce production costs or loads on the global environments or working environments caused by the solvent.

When the acrylic resin composition of the present invention is molded into films by the melt extrusion method, the acrylic resin composition of the present invention is first pre-dried and then fed to an extruder to heat melt the acrylic resin composition. Further, it is fed to a die such as a T die through a gear pump or a filter. Next, the acrylic resin composition fed to the T die is extruded as a sheet-like molten resin and cooled and solidified using a cooling roll or the like to obtain an unstretched film (also referred to as “raw material film”). When doing the above, it is also possible to sandwich the film between a metal roll and a flexible roll having a metal elastic outer tube in order to improve a surface property (smoothness) of the film.

When the acrylic resin composition of the present invention is molded into an unstretched film by the solution casting method, the acrylic resin composition of the present invention is formed into a solution together with an organic solvent, and then the solution is cast on a support and heated and dried to produce an unstretched film. Solvents that can be used in the solvent casting method can be selected from known solvents. Halogenated hydrocarbon solvents, such as methylenechloride and trichloroethane, are preferred solvents because they easily dissolve the inventive acrylic resin and have a low boiling point. In addition, highly polar non-halogen solvents such as dimethylformamide and dimethylacetamide can be used. In addition, aromatic solvents such as toluene, xylene and anisole, cyclic ether solvents such as dioxane, dioxolane, tetrahydrofuran and pyran, and ketone-based solvents such as methyl ethyl ketone can be used. These solvents may be used singly. Alternatively, two or more may be mixed and used. The used amount of the solvent can be any amount as long as the thermoplastic resin can be dissolved to an extent that casting can be performed sufficiently. In the present specification, “dissolved” means that the resin is present in the solvent in a uniform state to the extent that casting can be performed sufficiently. It is not necessary that the solute be completely dissolved in the solvent. The resin concentration in the solution is preferably from 1% to 90% by weight, more preferably from 5% to 70% by weight, and even more preferably from 10% to 50% by weight. As a preferable support, an endless belt made of stainless steel may be used. Alternatively, a film such as a polyimide film or a polyethylene terephthalate film can be used.

The stretched film of the present invention is obtained by stretching an unstretched film (also referred to as “raw material film”). By stretching the unstretched film, a stretched film having a desired thickness can be produced, or mechanical properties of the stretched film can be improved. As the stretching method, conventionally known methods can be used. For example, an unstretched raw material film molded by melt extrusion can be uniaxially stretched or biaxially stretched to produce a film of a predetermined thickness. In order to have excellent mechanical properties in both the longitudinal direction (MD direction) and the width direction (TD direction) of the stretched film, biaxial stretching is preferable. The stretching method may be simultaneous biaxial stretching or sequential biaxial stretching. The stretching ratio is preferably 1.5 to 3.0 times, more preferably 1.8 to 2.8 times (both in the MD direction and in the TD direction of the film in the case of biaxial stretching). When the stretching ratio is within this range, the mechanical properties of the film can be sufficiently improved by stretching. In addition, the degree of orientation does not excessively increase, the dimensional change when left to stand in an atmosphere at 85° C. and 85% RH for 120 hours can be reduced, and moreover, the possibility of lowering the peeling strength when bonded to a polarizer is also small. The stretching speed is preferably 1.1 times/minute or more, and more preferably 5 times/minute or more. Further, it is preferable that the stretching speed is 100 times/minute or less, and more preferable that the stretching speed is 50 times/minute or less. In the case of sequential biaxial stretching, the first stretching speed and the second stretching speed may be the same or different. In sequential biaxial stretching, typically, the first stretch is made in the longitudinal direction (MD direction) and the second stretch is made in the width direction (TD direction).

Stretching temperature is not particularly limited, and the lower limit of the stretching temperature may be the glass transition temperature (Tg)+20° C., Tg+21° C., Tg+22° C., Tg+25° C., Tg+26° C., Tg+29° C., Tg+30° C., Tg+31° C., Tg+36° C., Tg+41° C., Tg+45° C., or Tg+55° C. of the acrylic resin composition, and the upper limit of the stretching temperature may be Tg+55° C., Tg+45° C., Tg+41° C., or Tg+36° C. The combination of the lower limit of the stretching temperature and the upper limit of the stretching temperature is not particularly limited as long as the lower limit of the stretching temperature is equal to or less than the upper limit of the stretching temperature, and any combination may be used. The stretching temperature is preferably Tg+20° C. to Tg+55° C., more preferably Tg+25° C. to Tg+55° C., even more preferably Tg+30° C. to Tg+45° C., and particularly preferably Tg+35° C. to Tg+45° C. The stretching temperature may be Tg+31° C. to Tg+55° C., Tg+31° C. to Tg+45° C., Tg+31° C. to Tg+41° C., or Tg+31° C. to Tg+36° C. Within this range of the stretching temperature, the dimensional change rate tends to be small even when the film is left to stand in an atmosphere at 85° C. and 85% RH for 120 hours, and a concern that peel strength decreases when the film is bonded to another film such as a polarizer becomes low. In addition, it is possible to prevent reduction in the MIT double fold number normally caused by stretching at high temperatures, by adding the acrylic rubber particle. That is, setting the stretching temperature within the above range enables production of stretched films having a low dimensional change rate, being excellent in peel strength and MIT bending endurance and being well-balanced. From the viewpoint of film quality and the like, in the case of sequential biaxial stretching, it is preferable that the stretching temperature in the stretching in the width direction (TD direction) is equal to or higher than the stretching temperature in the stretching in the longitudinal direction (MD direction), and in particular, it is preferable that the stretching temperature in the stretching in the width direction (TD direction) performed as the second-stage stretching is equal to or higher than the stretching temperature in the stretching in the longitudinal direction (MD direction) performed as the first-stage stretching.

### (Applications)

When the stretched film of the present invention is used as a polarizer protective film, the stretched film of the present invention is bonded to a polarizer to form a polarizing plate. The polarizer is not particularly limited, and any known polarizer can be used. Examples of the polarizer include a polarizer obtained by blending iodine in stretched polyvinyl alcohol.

The polarizing plate is further bonded to various films and can be used for various products. Applications thereof are not particularly limited, but the polarizer can be suitably used in, for example, a field of displays such as a liquid crystal display or an organic EL display.

### EXAMPLES

The present invention is more specifically explained on the basis of the Examples and the Comparative Examples, but is not limited thereto. A person skilled in the art is allowed to change, revise or modify the present invention without deviating from the scope of the present invention.

### (Glass Transition Temperature)

The glass transition temperature was measured by using 10 mg of acrylic resin (A) or the acrylic resin composition, and a differential scanning calorimeter (DSC, manufacture by SII, DSC 7020) in a nitrogen-atmosphere at a heating rate of 20° C./min., and determined by the midpoint method.

### (MIT Bending Endurance Test)

The film was cut into a strip shape having a width of 15 mm, and this was used as a test piece. This test piece was measured using an MIT folding-resistance fatigue tester type D manufactured by Toyo Seiki Co., Ltd under the conditions of a test load of 1.96 N, speed of 175 counts/min., a curvature radius R of a folding clamp of 0.38 mm, and folding angle of 135° to the right and left sides. Folding test was performed in each of the MD direction and the TD direction and the arithmetic mean was defined as the MIT double fold number.

### (Internal Haze)

The films were measured using a haze meter NDH2000 manufactured by Nippon Denshoku Industries Co., Ltd. The internal haze was measured by placing the obtained film in a glass cell for liquid measurement and bringing distilled water into contact with both sides of the film.

### (Average Refractive Index)

Measurements were made using an Abbe refractometer 3T manufactured by Atago Co., Ltd.

### (Calculation of Content of Ring Structure)

The obtained acrylic resin (A) was measured using a ¹H-NMR BRUKER Avance III (400 MHz). The content of ring structure was calculated by converting the molar ratio of the ring structure portion, which is the target, and the other portions, into weight ratio. Specifically, in the case of glutarimide, the content of ring structure can be calculated by means of weight conversion of the molar ratio obtained using area A of the peak derived from protons of methyl methacrylate around 3.5 to 3.8 ppm and area B of the peak derived from N—CH₃ protons of glutarimide around 3.0 to 3.3 ppm.

### <Production of Acrylic Resin>

### (Production Example of Acrylic Resin (A1))

The extruder used was an intermeshing, co-rotating twin-screw extruder (L/D=90) with a bore diameter of 40 mm. The preset temperature of each temperature control zone of the extruder was set to 250 to 280° C., and the screw rotation speed was set to 85 rpm. Methyl methacrylate resin (Mw: 105,000) was fed at 42.4 kg/hr and was melted using a kneading block to fill the extruder, and then monomethylamine (manufactured by Mitsubishi Gas Chemical Company, Inc.) was injected through a nozzle in an amount of 1.8 parts by weight with respect to 100 parts by weight of the methyl methacrylate resin. The end of the reaction zone was equipped with a reverse flight so that the reaction zone was filled with the resin. The by-product and excessive methylamine after the reaction were removed by depressurizing the vent hole to -0.092 MPa. The resin was extruded as a strand from a die provided at the outlet of the extruder, cooled in a water bath, and pelletized in the pelletizer to obtain resin (I). Next, the temperature of temperature control zones of the intermeshing, co-rotating twin-screw extruder with a bore diameter of 40 mm was set to 240 to 260° C. and screw rotation number was set to 102 rpm. The obtained resin (I) was fed at 41 kg/hr from the hopper, and was melted using a kneading block to fill the extruder, and then dimethyl carbonate was injected through a nozzle in an amount of 0.56 parts by weight with respect to 100 parts by weight of the methyl methacrylate resin to reduce the carboxyl groups in the resin. The end of the reaction zone was equipped with a reverse flight so that the reaction zone was filled with the resin. The by-product and excessive dimethyl carbonate after the reaction were removed by depressurizing the vent hole to −0.092 MPa. The resin extruded as a strand from a die provided at the outlet of the extruder was cooled in a water bath, and pelletized in the pelletizer to obtain acrylic resin having a glutarimide ring (Al). The acrylic resin (Al) had a glutarimide content of 6% by weight, a glass transition temperature of 125° C., and an average refractive index of 1.50.

### (Production Example of Acrylic Resin (A2))

Acrylic resin (A2) having a glutarimide ring was obtained in the same manner as in Example 1, except that methyl methacrylate-styrene copolymer (styrene content: 11 mol %) was used instead of methyl polymethacylate resin (Mw: 105,000) and the supplied amount of monomethylamine was 14 parts by weight. The acrylic resin (A2) had a glutarimide content of 79% by weight, a glass transition temperature of 134° C., and an average refractive index of 1.53.

### <Production of Acrylic Rubber Particle>

### (Production Example of Acrylic Rubber Particle (B1))

A mixture having the following composition was charged into a glass reactor, and heated to 80° C., with stirring in a nitrogen stream. Then, 25% of a mixture solution comprising a monomer mixture and 0.1 parts of t-butyl hydroperoxide, the monomer mixture consisting of 27 parts of methyl methacrylate, 0.5 parts of allyl methacrylate and 0.1 parts of t-dodecyl mercaptan, was collectively charged, followed by polymerization for 45 minutes.

| | | |
|---|---|---|
| Deionized water | 220 | parts |
| Boric acid | 0.3 | parts |
| Sodium carbonate | 0.03 | parts |
| Sodium N-lauroyl sarcosinate | 0.09 | parts |
| Sodium formaldehyde sulfoxylate | 0.09 | parts |
| Disodium ethylenediaminetetraacetate | 0.006 | parts |
| Ferrous sulfate | 0.002 | parts |

Successively, the remaining 75% of this mixture solution was continuously added over 1 hour. After completion of the addition, the mixture was kept at the same temperature for 2 hours to complete the polymerization. During this time, 0.2 parts of sodium N-lauroyl sarcosinate was added. The polymerization conversion ratio (amount of polymer formed/amount of monomer charged) of the thus obtained innermost-layer crosslinked methacrylic polymer latex was 98°.

The resulting innermost polymer latex was maintained at 80° C. in a stream of nitrogen, 0.1 parts of potassium persulfate was added, and then a monomer mixture consisting of 41 parts of n-butyl acrylate, 9 parts of styrene and 1 part of allyl methacrylate was continuously added over 5 hours. During this period, 0.1 part of potassium oleate was added in three portions. After the addition of the monomer mixture solution was completed, 0.05 parts of potassium persulfate was further added to complete the polymerization, and the mixture was held for 2 hours. The obtained rubber particles had a polymerization conversion of 99° and a particle diameter of 240 nm.

The resulting rubber particle latex was kept at 80° C. and 0.05 parts of potassium persulfate was added, followed by continuous addition of a monomer mixture of 21.5 parts of methyl methacrylate and 1.5 parts of n-butyl acrylate over 1 hour. After addition of the monomer mixture solution was completed, the mixture was kept for 1 hour to obtain a graft copolymer latex. The polymerization conversion was 99%. The obtained rubber-containing graft copolymer latex was subjected to salting-out coagulation with calcium chloride, heat treatment, and drying to obtain acrylic rubber particle (B1) in the form of white powder.

### (Production Example of Acrylic Rubber Particle (B2))

A mixture having the following composition was charged into a glass reactor, and heated to 80° C. with stirring in a nitrogen stream. Then, 25% of a mixture solution comprising a monomer mixture and 0.1 parts of t-butyl hydroperoxide, the monomer mixture consisting of 21 parts of methyl methacrylate, 0.4 parts of allyl methacrylate and 0.08 parts of t-dodecyl mercaptan, was collectively charged, followed by polymerization for 45 minutes.

| | | |
|---|---|---|
| Deionized water | 220 | parts |
| Boric acid | 0.3 | parts |
| Sodium carbonate | 0.03 | parts |
| Sodium N-lauroyl sarcosinate | 0.09 | parts |
| Sodium formaldehyde sulfoxylate | 0.09 | parts |
| Disodium ethylenediaminetetraacetate | 0.006 | parts |
| Ferrous sulfate | 0.002 | parts |

Successively, the remaining 75% of this mixture solution was continuously added over 1 hour. After completion of the addition, the mixture was kept at the same temperature for 2 hours to complete the polymerization. During this time, 0.2 parts of sodium N-lauroyl sarcosinate was added. The polymerization conversion ratio (amount of polymer formed/amount of monomer charged) of the thus obtained innermost-layer crosslinked methacrylic polymer latex was 98%.

The resulting innermost polymer latex was maintained at 80° C. in a stream of nitrogen, 0.1 parts of potassium persulfate was added, and then a monomer mixture consisting of 32 parts of n-butyl acrylate, 7 parts of styrene and 0.8 parts of allyl methacrylate was continuously added over 5 hours. During this period, 0.1 parts of potassium oleate was added in three portions. After the addition of the monomer mixture solution was completed, 0.05 parts of potassium persulfate was further added to complete the polymerization, and the mixture was held for 2 hours. The obtained rubber particles had a polymerization conversion of 99% and a particle diameter of 240 nm.

The resulting rubber particle latex was kept at 80° C. and 0.05 parts of potassium persulfate was added, followed by continuous addition of a monomer mixture of 34 parts of methyl methacrylate, 3 parts of n-butyl acrylate and 3 parts of acrylonitrile over 1 hour. After addition of the monomer mixture solution was completed, the mixture was kept for 1 hour to obtain a graft copolymer latex. The polymerization conversion was 99%. The obtained rubber-containing graft copolymer latex was subjected to salting-out coagulation with calcium chloride, heat treatment, and drying to obtain acrylic rubber particle (B2) in the form of white powder.

### Example 1

A mixture containing acrylic resin (A1) produced in the Production Example of acrylic resin and 10% by weight of acrylic rubber particle (B1) was kneaded by an intermeshing co-rotating twin-screw extruder (L/D=30) having a bore diameter of 15 mm. The resin mixture was supplied from the hopper at 2 kg/hr, and the preset temperature of each of the temperature control zones of the extruder was set to 260° C. and the screw rotation number was set to 100 rpm. The resin extruded as a strand from a die provided at the outlet of the extruder was cooled in a water bath, and pelletized in the pelletizer to obtain acrylic resin (C1).

The resulting acrylic resin composition (C1) was dried at 100° C. for 5 hours and then formed into a film using an intermeshing co-rotating twin-screw extruder (L/D=30) having a bore diameter of 15 mm equipped with a T-die at the extruder outlet. Acrylic resin composition (C1) was fed from the hopper at a rate of 2 kg/hr, and the preset temperature of the temperature control zones of the extruder was set to 270° C. and the screw rotation number was set to 100 rpm. Sheet-like molten resin extruded from a T-die provided at the outlet of the extruder was cooled by cooling rolls to obtain raw material film (D1) having a width of 160 mm and a thickness of 160 μm.

The glass transition temperature of the raw material film was measured according to the method described above and found to be 124° C.

Obtained raw material film (D1) was subjected to simultaneous biaxial stretching at a temperature of 21° C. higher than the glass transition temperature by stretching ratio of two times (vertical and horizontal) using a biaxial film stretcher (IMC-1905) manufactured by Imoto machinery Co., Ltd. to prepare stretched film (El).

Shrinkage ratio, peel strength, and MIT double fold number were measured according to the methods described above. The results are shown in Table 1. The internal haze was measured to be 0.17.

### (Shrinkage Ratio)

Stretched film (El) obtained as described above was cut out to a size of 90 mm×90 mm by using a cutter, and holes were made at positions of 20 mm diagonally inward from the four corners of the film by using a punch of Φ1 mm, and spacings between holes were measured by using MF201 type three-dimensional measuring instrument manufactured by Mitsutoyo. Subsequently, the stretched film whose hole spacings had been measured was left to stand for 120 hours in a LH-20 type environmental testing machine manufactured by Nagano Science set at 85° C. and 85% RH, and then the hole spacings were measured again. Shrinkage ratio was calculated from the differences between the hole spacings before and after being left to stand in 85° C. and 85% RH atmosphere.

### (Corona Discharge Treatment)

Corona discharge treatment (corona discharge electron dose of 100 W/m²/min) was performed on one side of raw material film D1 thus obtained to obtain a corona-discharge-treated film (F1).

### (Formation of Easy Adhesion Layer)

To 100 g of a water-borne urethane resin having a carboxyl group (DKS Co., Ltd., trade name: Superflex 210, solid content: 33%), 20 g of a crosslinking agent (Nippon Shokubai Co., Ltd., trade name: Epocros WS700, solid content: 25%) was added and stirred for 3 minutes to obtain an easy adhesive composition. The obtained easy adhesive composition was applied by using a bar coater (Rod No. 6) to a corona-discharge-treated surface of raw material film D1 subjected to the corona discharge treatment. Raw material film D1 coated with the easy adhesive was put into a hot air dryer (80° C.) and the urethane composition was dried for about 1 minute to obtain easy adhesive-treated film (G1) on which an easy adhesive layer was formed.

### (Peel Strength)

A biaxially stretched film was prepared by performing simultaneous biaxial stretch of the thus-obtained easy adhesive-treated film (G1) by using a biaxial film stretcher (IMC-1905) manufactured by Imoto Machinery Co., Ltd. at a stretching ratio of two times (vertical and horizontal) and at a temperature 21° C. higher than the glass transition temperature. The thickness of the easy adhesive layer after biaxial stretching was 0.38 pm. The obtained biaxially stretched film was cut out in a strip shape having a width of 15 mm and a length of 10 cm, onto one surface thereof on which the easy adhesive layer was applied, 6 drops of “Aron Alpha Series” (Aron Alpha No. 1 for Professional Use) manufactured by Toagosei were dropped, “Elmech Series” (R film, thickness: 64 μm) manufactured by Kaneka Co., Ltd. was cut out in a strip shape having a width of 15 mm and a length of 10 cm and the strip was uniformly adhered by using a rubber roller (according to JIS Z 0237) having a weight of 2 kg. The obtained stretched film to which the polycarbonate film was adhered was cut into a strip shape having a width of 1 cm using a cutter to obtain a peel strength test sample. The obtained peel strength test sample was attached to a table made of stainless steel using “polyethylene cloth double-sided tape (50 mm×15 m)” manufactured by Sekisui Chemical Co., Ltd. so that the stretched film side was on the lower side and the polycarbonate film was on the upper side, and the strength at the time of peeling the polycarbonate film from the stretched film by 90 degrees was used as the peel strength. The peel strength in this case was obtained by performing measurement using a compact table-top tester (autograph) EZ-S manufactured by Shimadzu Corporation under an environment at 23° C./50% RH, and averaging data whose peeling length in the peel strength test was between 10 mm to 60 mm in the measurement data obtained under the condition of peel rate 30 ram/min. Measurements were performed three times and arithmetic mean values were used as the peel strength. The results are shown in Table 1.

### Example 2

A biaxially stretched film was produced by performing the same operations as in Example 1, except that raw material film (D1) was subjected to simultaneous biaxial stretching at a temperature 26° C. higher than the glass transition temperature. The shrinkage ratio, the peel strength, and the MIT double fold number were measured according to the methods described above. The results are shown in Table 1. The internal haze was measured to be 0.18.

### Example 3

A biaxially stretched film was produced by performing the same operations as in Example 1 except that raw material film (D1) was subjected to simultaneous biaxial stretching at a temperature 31° C. higher than the glass transition temperature. The shrinkage ratio, the peel strength, and the MIT double fold number were measured according to the methods described above. The results are shown in Table 1. The internal haze was measured to be 0.19.

### Example 4

A biaxially stretched film was produced by performing the same operations as in Example 1, except that raw material film (D1) was subjected to simultaneous biaxial stretching at a temperature 36° C. higher than the glass transition temperature.

The shrinkage ratio, the peel strength, and the MIT double fold number were measured according to the methods described above. The results are shown in Table 1. The internal haze was measured to be 0.18.

### Example 5

A biaxially stretched film was produced by performing the same operations as in Example 1, except that raw material film (D1) was subjected to simultaneous biaxial stretching at a temperature 41° C. higher than the glass transition temperature. The shrinkage ratio, the peel strength, and the MIT double fold number were measured according to the methods described above. The results are shown in Table 1. The internal haze was measured to be 0.17.

### Example 6

A biaxially stretched film was produced by performing the same operations as in Example 1, except that the content of acrylic rubber particle (B1) was changed to 15% by weight and the simultaneous biaxial stretching was performed at a temperature 26° C. higher than the glass transition temperature. The shrinkage ratio, the peel strength, and the MIT double fold number were measured according to the methods described above. The results are shown in Table 1. The internal haze was measured to be 0.19.

### Example 7

A biaxially stretched film was produced by performing the same operations as in Example 1, except that the content of acrylic rubber particle (B1) was changed to 15% by weight and the simultaneous biaxial stretching was performed at a temperature 31° C. higher than the glass transition temperature. The shrinkage ratio, the peel strength, and the MIT double fold number were measured according to the methods described above. The results are shown in Table 1. The internal haze was measured to be 0.20.

### Example 8

A biaxially stretched film was produced by performing the same operations as in Example 1, except that acrylic resin (A2) was used instead of acrylic resin (A1), 23% by weight of acrylic rubber particle (B2) was used instead of acrylic resin particle (Bl) and the simultaneous biaxial stretching was performed at a temperature 22° C. higher than the glass transition temperature. The shrinkage ratio, the peel strength, and the MIT double fold number were measured according to the methods described above. The results are shown in Table 1.

### Example 9

A biaxially stretched film was produced by performing the same operations as in Example 1, except that acrylic rubber particle (B2) was used in a content of 23% by weight instead of acrylic resin particle (Bl) and the simultaneous biaxial stretching was performed at a temperature 29° C. higher than the glass transition temperature. The shrinkage ratio, the peel strength, and the MIT double fold number were measured according to the methods described above. The results are shown in Table 1. The internal haze was measured to be 0.17.

### Example 10

Acrylic resin (A1) and 10% by weight of acrylic rubber particle (B1) were dissolved in methylenechloride to obtain a solution with a solid content of 15% by weight. This solution was cast onto a biaxially stretched polyethylene terephthalate film laid on a glass plate. The resulting sample was left to stand at room temperature for 60 minutes. Thereafter, the sample was peeled off from the polyethylene terephthalate film, the four sides of the sample were fixed, dried at 100° C. for 10 minutes, and further dried at 140° C. for 10 minutes to obtain a raw material film (Dl') having a thickness of 160 pm. A biaxially stretched film was produced by performing the same operations as in Example 1 except that the stretching temperature was changed to a temperature 36° C. higher than the glass transition temperature. The shrinkage ratio, the peel strength, and the MIT double fold number were measured according to the methods described above. The results are shown in Table 1. The internal haze was measured to be 0.16.

### Comparative Example 1

A biaxially stretched film was produced by performing the same operations as in Example 1, except that 5% by weight of acrylic rubber particle (B1) was used and the simultaneous biaxial stretching was performed at a temperature 11° C. higher than the glass transition temperature. The shrinkage ratio, the peel strength, and the MIT double fold number were measured according to the methods described above. The results are shown in Table 1. The internal haze was measured to be 0.23.

### Comparative Example 2

A biaxially stretched film was produced by performing the same operations as in Example 1, except that the simultaneous biaxial stretching was performed at a temperature 11° C. higher than the glass transition temperature. The shrinkage ratio, the peel strength, and the MIT double fold number were measured according to the methods described above. The results are shown in Table 1. The internal haze was measured to be 0.25.

### Comparative Example 3

A biaxially stretched film was produced by performing the same operations as in Example 1, except that 15° by weight of acrylic rubber particle (B1) was used and the simultaneous biaxial stretching was performed at a temperature 16° C. higher than the glass transition temperature. The shrinkage ratio, the peel strength, and the MIT double fold number were measured according to the methods described above. The results are shown in Table 1. The internal haze was measured to be 0.27.

### Comparative Example 4

A biaxially stretched film was produced by performing the same operations as in Example 1, except that acrylic rubber particle (B2) was used in a content of 23% by weight instead of acrylic rubber particle (B1) and the simultaneous biaxial stretching was performed at a temperature 12° C. higher than the glass transition temperature. The shrinkage ratio, the peel strength, and the MIT double fold number were measured according to the methods described above. The results are shown in Table 1. The internal haze was measured to be 0.13.

### Comparative Example 5

A biaxially stretched film was produced by performing the same operations as in Example 1, except that acrylic rubber particle (B2) was used in a content of 23% by weight instead of acrylic rubber particle (B1) and the simultaneous biaxial stretching was performed at a temperature 19° C. higher than the glass transition temperature. The shrinkage ratio, the peel strength, and the MIT double fold number were measured according to the methods described above. The results are shown in Table 1. The internal haze was measured to be 0.14.

### Comparative Example 6

A biaxially stretched film was produced by performing the same operations as in Example 1, except that acrylic resin (A2) was used instead of acrylic resin (A1), 23% by weight of acrylic rubber particle (B2) was used instead of acrylic resin particle (B1) and the simultaneous biaxial stretching was performed at a temperature 19° C. higher than the glass transition temperature. The shrinkage ratio, the peel strength, and the MIT double fold number were measured according to the methods described above. The results are shown in Table 1.

### Comparative Example 7

A biaxially stretched film was produced by performing the same operations as in Example 1, except that acrylic rubber particle (B1) was not added and the simultaneous biaxial stretching was performed at a temperature 20° C. higher than the glass transition temperature. The shrinkage ratio, the peel strength, and the MIT double fold number were measured according to the methods described above. The results are shown in Table 1. The internal haze was measured to be 0.15.

### Comparative Example 8

A biaxially stretched film was produced by performing the same operations as in Example 1, except that acrylic resin (A2) was added instead of acrylic resin (A1), acrylic rubber particle (B1) was not added and the simultaneous biaxial stretching was performed at a temperature 11° C. higher than the glass transition temperature. The shrinkage ratio, the peel strength, and the MIT double fold number were measured according to the methods described above. The results are shown in Table 1. The internal haze was measured to be 0.15.

### Comparative Example 9

A biaxially stretched film was produced by performing the same operations as in Example 1, except that the simultaneous biaxial stretching was performed at a temperature 61° C. higher than the glass transition temperature. The MIT bending endurance test was performed according the method described above and the MIT double fold number was 130 counts.

TABLE 1

| | | | Addition | | | | | | Shrinkage | |
|---|---|---|---|---|---|---|---|---|---|---|
| | | | amount of | | | | | | ratio at 85° C., | MIT fold |
| | | | acrylic | Glass | | | | | 85% RH for | number |
| | | Acrylic | rubber | transition | Raw | Stretching | Stretching | Peel | 120 hours | (Average |
| | Acrylic | rubber | particle (% | point | material | temperature | temperature | strength | (Average of | of MD/TD, |
| | resin | particle | by weight) | (° C.) | film | (° C.) | −Tg (° C.) | (N/cm) | MD/TD, %) | counts) |
| Example 1 | A1 | B1 | 10 | 124 | D1 | 145 | 21 | 0.9 | 1.5 | 480 |
| Example 2 | A1 | B1 | 10 | 124 | D1 | 150 | 26 | 1.06 | 1.3 | 450 |
| Example 3 | A1 | B1 | 10 | 124 | D1 | 155 | 31 | 1.37 | 1.0 | 430 |
| Example 4 | A1 | B1 | 10 | 124 | D1 | 160 | 36 | 1.73 | 0.8 | 400 |
| Example 5 | A1 | B1 | 10 | 124 | D1 | 165 | 41 | 2.05 | 0.6 | 380 |
| Example 6 | A1 | B1 | 15 | 124 | D2 | 150 | 26 | 1.1 | 1.2 | 720 |
| Example 7 | A1 | B1 | 15 | 124 | D2 | 155 | 31 | 1.36 | 0.8 | 700 |
| Example 8 | A2 | B2 | 23 | 132 | D3 | 154 | 22 | 1.2 | 0.1 | 370 |
| Example 9 | A1 | B2 | 23 | 123 | D4 | 152 | 29 | 1.17 | 1.4 | 480 |
| Example 10 | A1 | B1 | 10 | 124 | D1′ | 160 | 36 | 1.7 | 0.9 | 420 |
| Comparative | A1 | B1 | 5 | 124 | D5 | 135 | 11 | 0.68 | 1.8 | 390 |
| Example 1 | | | | | | | | | | |
| Comparative | A1 | B1 | 10 | 124 | D1 | 135 | 11 | 0.6 | 1.9 | 530 |
| Example 2 | | | | | | | | | | |
| Comparative | A1 | B1 | 15 | 124 | D2 | 140 | 16 | 0.77 | 1.8 | 800 |
| Example 3 | | | | | | | | | | |
| Comparative | A1 | B2 | 23 | 123 | D4 | 135 | 12 | 0.49 | 3.5 | 440 |
| Example 4 | | | | | | | | | | |
| Comparative | A1 | B2 | 23 | 123 | D4 | 142 | 19 | 0.65 | 2.6 | 440 |
| Example 5 | | | | | | | | | | |
| Comparative | A2 | B2 | 23 | 123 | D3 | 142 | 19 | 0.91 | 1.0 | 550 |
| Example 6 | | | | | | | | | | |
| Comparative | A1 | — | 0 | 125 | D6 | 145 | 20 | 2 | 1.3 | 330 |
| Example 7 | | | | | | | | | | |
| Comparative | A2 | — | 0 | 134 | D7 | 145 | 11 | 1.9 | 0.4 | 270 |
| Example 8 | | | | | | | | | | |

It can be seen from Table 1 that setting the stretching temperature within such a range allows to prevent an increase (worsening) in dimensional change rate caused by addition of acrylic rubber particles, to suppress cohesive fracture caused by acrylic rubber particles, and to render the acrylic rubber particle-containing stretched film excellent in balance among mechanical properties, dimensional stability, and peel strength. Inter alia, in Example 3 to 5, 7 and 10, in which the stretching temperature was 155 to 165° C., the dimensional stability and the peel strength were particularly excellent. It can be seen to be able to render a stretched film containing acrylic rubber particles excellent in balance among mechanical properties, dimensional stability, and peel strength.

1. A method of producing a stretched film, comprising:
stretching an unstretched film comprising an acrylic resin composition comprising an acrylic resin having a glass transition temperature of 120° C. or more and an acrylic rubber particle,
wherein a content of the acrylic rubber particle in the acrylic resin composition is 1% by weight to 50% by weight, and
the stretching is performed at a temperature of +20° C. to +55° C. of a glass transition temperature (T_{g}) of the acrylic resin composition.

2. The method according to claim 1, wherein the stretched film has a shrinkage ratio of 1.5% or less when the stretched film is left to stand in an atmosphere of 85° C. and 85% RH for 120 hours, and an MIT double fold number of 350 counts or more.

3. The method according to claim 1,
wherein the acrylic rubber particle has a core layer comprising a rubber-like polymer and a shell layer comprising a glass-like polymer, and
an average dispersion length of the acrylic rubber particle is 150 nm to 300 nm.

4. The method according to claim 1, wherein, when the stretched film is attached to a polycarbonate film with an adhesive, a value of 90° peel strength tested by peeling the polycarbonate film from the stretched film in an atmosphere of 23° C. and 50% RH is 1.0 N/cm or more.

5. The method according to claim 1, wherein the acrylic resin having a glass transition temperature of 120° C. or more has a ring structure in a main chain.

6. The method according to claim 5, wherein the ring structure is at least one selected from the group consisting of a glutarimide ring, a lactone ring, maleic anhydride, maleimide and glutaric anhydride.

7. The method according to claim 5, wherein a content of the ring structure in the acrylic resin having a glass transition temperature of 120° C. or more is 2% by weight to 80% by weight.

8. The method according to claim 5, wherein the ring structure has the following gformula (1) 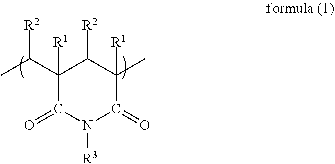
wherein R¹ and R² each independently represent a hydrogen atom or an alkyl group having 1 to 8 carbon atoms, and R³ represents an alkyl group having 1 to 18 carbon atoms, a cycloalkyl group having 3 to 12 carbon atoms or an aryl group having 6 to 10 carbon atoms.

9. The method according to claim 1, wherein the stretched film has a shrinkage ratio of 0.1% or more and 1.5% or less when the stretched film is left to stand in an atmosphere of 85° C. and 85% RH for 120 hours.

10. The method according to claim 1, further comprising:
forming an easy adhesive layer on one surface or each of both surfaces of the stretched film.

11. A stretched film, comprising:
an acrylic resin having a glass transition temperature of 120° C. or more; and
an acrylic rubber particle in a content of 1% by weight to 50% by weight,
wherein the stretched film has a shrinkage ratio of 1.5% or less when the stretched film is left to stand in an atmosphere of 85° C. and 85% RH for 120 hours, and an MIT double fold number of 350 counts or more.

12. The stretched film according to claim 11,
wherein the acrylic rubber particle has a core layer comprising a rubber-like polymer and a shell layer comprising a glass-like polymer, and
an average dispersion length of the acrylic rubber particle is 150 nm to 300 nm.

13. The stretched film according to claim 11, wherein, when the stretched film is attached to a polycarbonate film with an adhesive, a value of 90° peel strength tested by peeling the polycarbonate film from the stretched film in an atmosphere of 23° C. and 50% RH is 1.0 N/cm or more.

14. The stretched film according to claim 11, wherein the acrylic resin having a glass transition temperature of 120° C. or more has a ring structure in a main chain.

15. The stretched film according to claim 14, wherein the ring structure is at least one selected from the group consisting of a glutarimide ring, a lactone ring, maleic anhydride, maleimide and glutaric anhydride.

16. The stretched film according to claim 14, wherein a content of the ring structure in the acrylic resin having a glass transition temperature of 120° C. or more is 2% by weight to 80% by weight.

17. The stretched film according to claim 14, wherein the ring structure has the following formula (1) 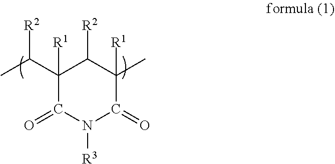
wherein R¹ and R² each independently represent a hydrogen atom or an alkyl group having 1 to 8 carbon atoms, and R³ represents an alkyl group having 1 to 18 carbon atoms, a cycloalkyl group having 3 to 12 carbon atoms or an aryl group having 6 to 10 carbon atoms.

18. The stretched film according to claim 11, wherein the stretched film has a shrinkage ratio of 0.1% or more and 1.5% or less when the stretched film is left to stand in an atmosphere of 85° C. and 85% RH for 120 hours.

19. The stretched film according to claim 11, wherein the stretched film comprises an easy adhesive layer on one surface or each of both surfaces.
